(19) United States
(12) Patent Application Publication
(10) Pub. No.: US 2010/0315335 A1
(43) Pub. Date: Dec. 16, 2010

(54) Pointing Device with Independently Movable Portions

(75) Inventors: Nicolas Villar, Cambridge (GB); John Helmes, Cambridge (GB); Shahram Izadi, Cambridge (GB); Daniel Rosenfeld, Seattle, WA (US); Stephen E. Hodges, Cambridge (GB); David Alexander Butler, Cambridge (GB); Xiang Cao, Cambridge (GB); Otmar Hilliges, Munich (DE); Richard Banks, Egham (GB); Benjamin David Eidelson, Seattle, WA (US); Hrvoje Benko, Seattle, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/485,543

(22) Filed: Jun. 16, 2009

(51) Int. Cl. G06F 3/033

(52) U.S. Cl. 345/158

(57) ABSTRACT

A pointing device with independently movable portions is described. In an embodiment, a pointing device comprises a base unit and a satellite portion. The base unit is arranged to be located under a palm of a user's hand and be movable over a supporting surface. The satellite portion is arranged to be located under a digit of the user's hand and be independently movable over the supporting surface relative to the base unit. In embodiments, data from at least one sensing device is read, and movement of both the base unit and the independently movable satellite portion of the pointing device is calculated from the data. The movement of the base unit and the satellite portion is analyzed to detect a user gesture.

### BACKGROUND

Pointing devices are widely used to support human-computer interaction. Current pointing devices allow the user to move an on-screen cursor using movements of their arm and wrist (e.g. in the case of computer mouse devices) or their fingers and thumb (e.g. in the case of touch-pads and trackballs). Most users prefer mouse devices for regular use on a desktop setting. Mouse devices are generally considered to be more comfortable for extended use than other alternatives.

The traditional computer mouse detects two-dimensional motion relative to the surface upon which it is placed, and includes one or more buttons for binary input (known as ‘clicking’). Since its inception in the 1960s, the computer mouse has undergone several decades of iterative refinement. For example, mouse devices now offer high fidelity sensing of a user's movement due to high-resolution optical sensors that can be used to track displacement over many types of surface. The basic mouse functionality has also been augmented with additional capabilities, the most successful of which has been the addition of the scroll wheel. Modern mouse devices are ergonomically designed to be held in a single hand and require little effort to use. Such refinements have resulted in the computer mouse becoming a very well-established device for desktop users. Nevertheless, the basic mouse concept and functionality has remained essentially unchanged.

Humans are naturally dexterous and use their fingers and thumbs to perform a variety of complex interactions with everyday objects to a high precision. Certain input movements and gestures are more easily accomplished by using the fine motor control of one or more fingers and thumb, rather than the gross motor control of the arm and wrist. For example, moving an object a fraction of a millimetre, or tracing an accurate path (for example, when drawing or writing) can be more quickly, easily and exactly accomplished by using fingers and thumb rather than with the arm and wrist. The traditional computer mouse design, however, makes little use of this dexterity, reducing our hands to a single cursor on the screen. Our fingers are often relegated to performing relatively simple actions such as clicking the buttons or rolling the scroll wheel.

The embodiments described below are not limited to implementations which solve any or all of the disadvantages of known pointing devices.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A pointing device with independently movable portions is described. In an embodiment, a pointing device comprises a base unit and a satellite portion. The base unit is arranged to be located under a palm of a user's hand and be movable over a supporting surface. The satellite portion is arranged to be located under a digit of the user's hand and be independently movable over the supporting surface relative to the base unit. In embodiments, data from at least one sensing device is read, and movement of both the base unit and the independently movable satellite portion of the pointing device is calculated from the data. The movement of the base unit and the satellite portion is analyzed to detect a user gesture.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates a pointing device having an independently movable portion;

FIG. 2 illustrates a flowchart for processing data from the pointing device to manipulate an on-screen cursor;

FIG. 3 illustrates a first example use of the pointing device to manipulate an on-screen cursor;

FIG. 4 illustrates a second example use of the pointing device to manipulate an on-screen cursor;

FIG. 5 illustrates a flowchart for processing data from the pointing device to detect a user gesture;

FIG. 6 illustrates an example gesture using the pointing device;

FIG. 7 illustrates a pointing device having two independently movable portions;

FIG. 8 illustrates a first example multi-touch gesture using the pointing device;

FIG. 9 illustrates a second example multi-touch gesture using the pointing device;

FIG. 10 illustrates an alternative movement sensor arrangement for the pointing device;

FIG. 11 illustrates an image capture-based sensor arrangement for the pointing device;

FIG. 12 illustrates an alternative image capture-based sensor arrangement for the pointing device;

FIG. 13 illustrates a further alternative image capture-based sensor arrangement for the pointing device;

FIG. 14 illustrates examples of alternative configurations of the pointing device; and

FIG. 15 illustrates an exemplary computing-based device in which embodiments of the pointing device can be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in combination with a desktop computing system, the system described is provided as an example and not a limitation. As those skilled in the art will appreciate, the present examples are suitable for application in a variety of different types of systems using human-computer interaction.

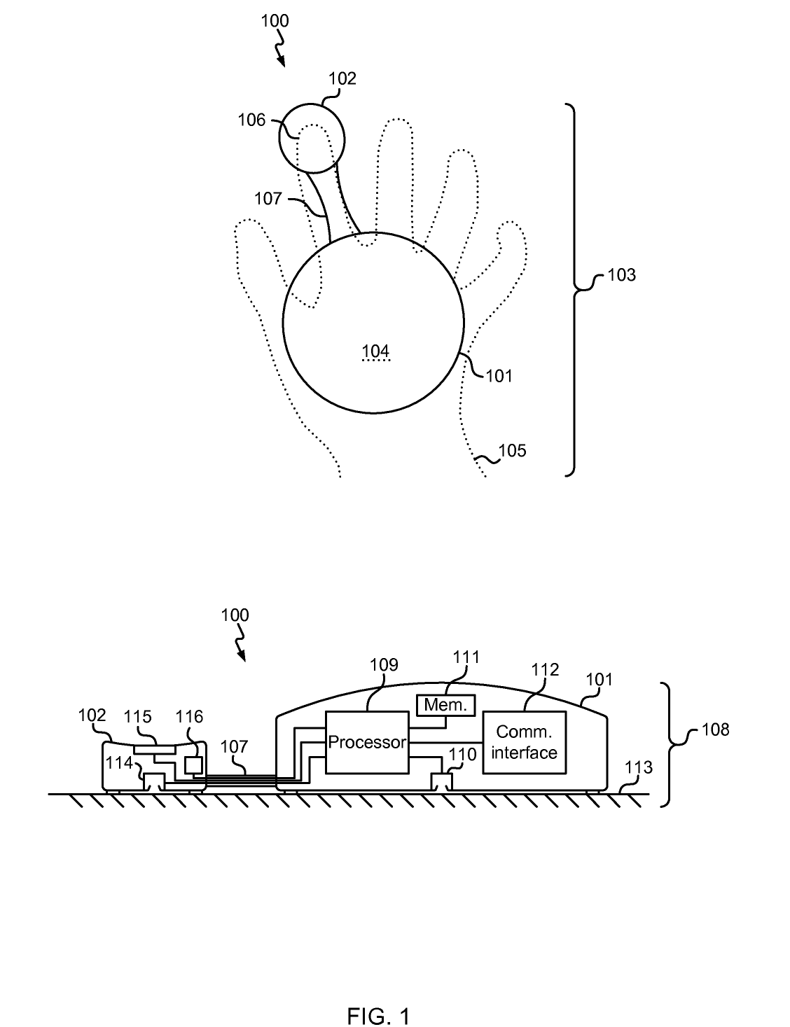

FIG. 1 illustrates a schematic diagram of a pointing device 100 comprising a base unit 101 and a satellite portion 102. As shown in the top-down view 103, the base unit is arranged to be located under a palm 104 of a hand 105 of a user of the pointing device. The satellite portion is arranged to be located under a digit 106 of the user's hand 105. Note that the term ‘digit’ is intended herein to encompass both fingers and thumbs of the user.

In the example of FIG. 1, the satellite portion 102 is tethered to the base unit 101 by an articulated member 107. In other examples, however, the satellite portion 102 can be tethered using a different type of member, or not tethered to the base unit 101, as described in more detail hereinafter.

As shown in side view 108, the base unit 101 of FIG. 1 comprises a processor 109, a movement sensor 110, a memory 111 and a communication interface 112. The movement sensor 110, memory 111, and communication interface 112 are each connected to the processor 109.

The movement sensor 110 is arranged to detect movement of the base unit 101 relative to a supporting surface 113 over which the base unit 101 is moved. The movement sensor 110 outputs a data sequence to the processor 109 that relates to the movement of the base unit 101. The data sequence can be in the form of an x and y displacement in the plane of the surface in a given time. Alternatively, raw data (e.g. in the form of images or a signal having a certain frequency) can be provided to the processor 109, and the processor 109 can determine the x and y displacement from the raw data. Preferably, the movement sensor 110 is an optical sensor, although any suitable sensor for sensing relative motion over a surface can be used (such as ball or wheel-based sensors).

The memory 111 is arranged to store data and instructions for execution on the processor 109. The communication interface 112 is arranged to communicate with a user terminal. For example, the communication interface 112 can communicate with the user terminal via a wired connection (such as USB) or via a wireless connection (such a Bluetooth).

The satellite portion 102 comprises a further movement sensor 114 connected to the processor 109 via the articulated member 107. The further movement sensor 114 is arranged to detect movement of the satellite portion 102 relative to the supporting surface 113 over which the satellite portion 102 is moved. The further movement sensor 114 outputs a data sequence to the processor 109 that relates to the movement of the satellite portion 102. The data sequence can be in the form of an x and y displacement in the plane of the surface in a given time. Alternatively, raw data (e.g. in the form of images or a signal having a certain frequency) can be provided to the processor 109, and the processor 109 can determine the x and y displacement from the raw data.

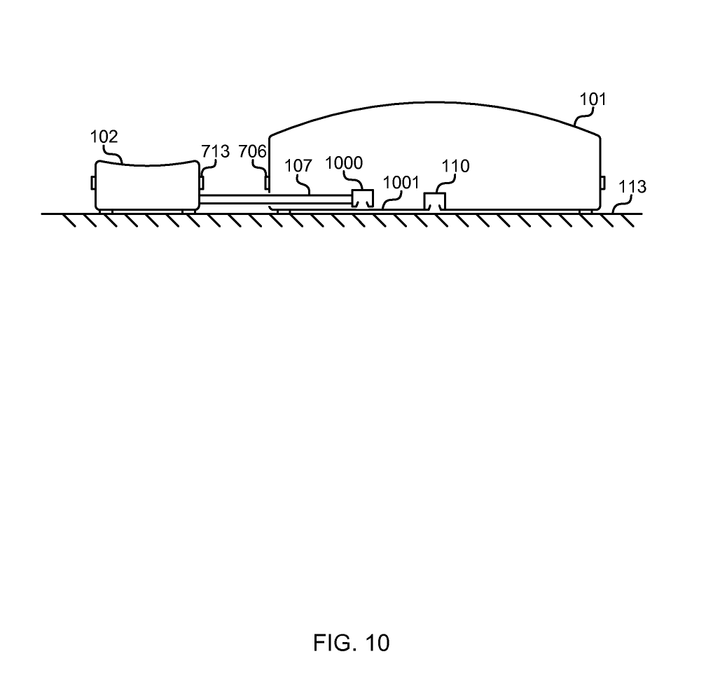

The further movement sensor 114 in the satellite portion 102 can be, for example, an optical sensor, although any suitable sensor for sensing relative motion over a surface can be used (such as ball or wheel-based sensors). Also note that an alternative sensing device for sensing the movement of the satellite portion can be used instead of a movement sensor located within the satellite portion 102, as outlined below with reference to FIGS. 10 to 13.

The satellite portion 102 further comprises a button 115 connected to the processor 109 via the articulated member 107, and arranged to provide a signal to the processor 109 when activated by the user. The button 115 can provide analogous input to a ‘mouse click’ on a traditional computer mouse device. In alternative examples, a pressure sensor or other user-actuatable control can be used instead of, or in combination with, the button 115. The pointing device 100 can also comprise further (or alternative) buttons located in the base unit 101 (not shown in FIG. 1), which can be actuated by depressing the user's palm or by the user's digits.

The satellite portion 102 further comprises an optional haptic feedback actuator 116 connected to the processor 109 via the articulated member 107. The haptic feedback actuator 116 is arranged to provide haptic feedback to the digit 106 of the user's hand 105 responsive to a command signal from the processor 109. For example, the haptic feedback can be in the form of a vibration generated by the haptic feedback actuator 116. The haptic feedback actuator 116 can also comprise an electro-mechanical and/or magnetic actuator arranged to cause changes to the surface of the satellite portion 102 and provide touch input to the user's digit 106.

In use, the base unit 101 is arranged to be movable over the supporting surface 113 (such as a desk or table top). The satellite portion 102 is also arranged to be movable over the supporting surface, and is independently movable relative to the base unit 101. In other words, the tethering (if present) between the satellite portion 102 and the base unit 101 is such that these two elements can be moved separately, individually, and in differing directions if desired.

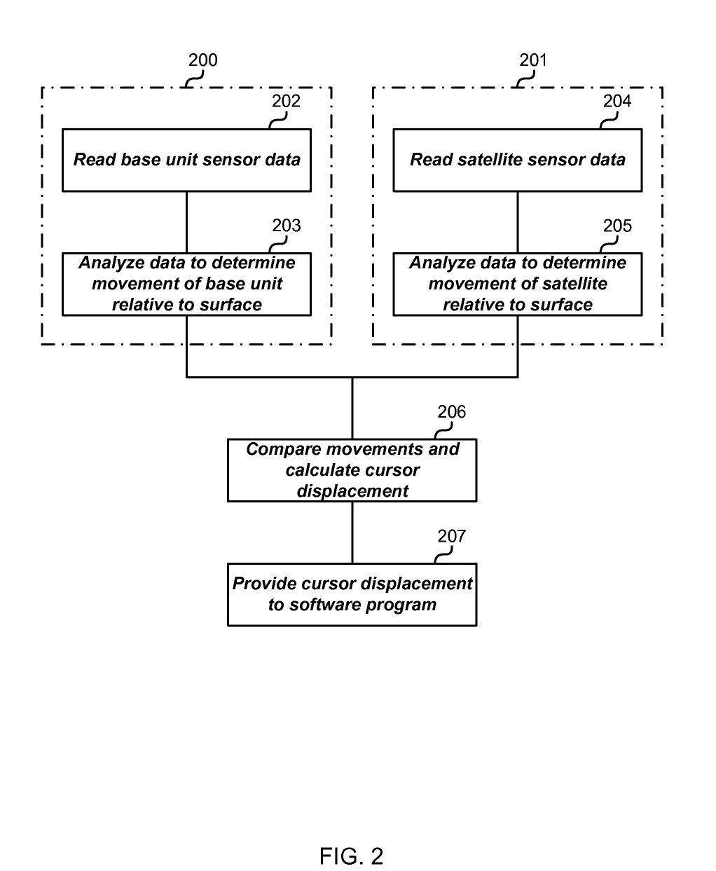

Reference is now made to FIG. 2, which illustrates a first example process for operating the pointing device 100 of FIG. 1. FIG. 2 shows a process performed to process the data from the movement sensor 110 of the base unit 101 and the further movement sensor 114 of the satellite portion 102. Note that the process shown in FIG. 2 can be performed by the processor 109 in the base unit 101, or, alternatively, the processor 109 can be arranged to transmit the sensor data to the user terminal (via the communication interface 112), and the user terminal can perform the process of FIG. 2. In a further alternative example, the processing of the processes in FIG. 2 can be split between the processor 109 and the user terminal.

The example process shown in FIG. 2 illustrates how the pointing device 100 can be used to manipulate an on-screen cursor. FIG. 2 shows two branches which can be processed substantially concurrently. A first branch 200 processes data from the movement sensor 110 in the base unit 101, and a second branch 201 processes data from the further movement sensor 114 in the satellite portion 102. Whilst these two branches can be analyzed in parallel, they can also be alternately performed in a time sequence, such that, from the perspective of the user, they appear to be substantially concurrent.

Considering the first branch 200, firstly the data from the movement sensor 110 of the base unit 101 is read 202. As mentioned above, the data from the movement sensor 110 is a sequence relating to the movement of the movement sensor 110 over a surface. In the case of an optical movement sensor, this can be in the form of a sequence of small images of the surface captured at known time intervals.

The data from the base unit movement sensor 110 is then analyzed 203. The analysis of the data determines the movement of the base unit 101 relative to the surface 113 in a given timeframe. For example, in the case of an optical movement sensor, an image of the surface can be compared to a previously obtained image, and a displacement between the images calculated. As the time between capturing the images is known, the motion (in terms of two-dimensional coordinates) of the base unit 101 in that time can be determined.

Considering now the second branch 201 (the processing of which is performed substantially concurrently with the first branch 200), the data from the satellite portion movement sensor 114 is read 204. As above, the data from the satellite portion movement sensor 114 is a sequence relating to the movement of the movement sensor 114 over a surface. For example, this can be in the form of a sequence of small images of the surface captured at known time intervals in the case of an optical movement sensor.

The satellite portion movement sensor 114 data is then analyzed 205. As above, this analysis determines the movement of the satellite portion 102 relative to the surface 113 in a given timeframe. In the case of an optical movement sensor, an image of the surface can be compared to a previously obtained image, and a displacement between the images calculated. As the time between capturing the images is known, the motion (in terms of two-dimensional coordinates) of the satellite portion 102 in that time can be determined.

The movement information from both the base unit 101 and the satellite portion 102 is compared 206 to generate an overall movement for the pointing device 100. The comparison operation can apply weightings to the movement of each of the base unit 101 and the satellite portion 102, as described below. The overall movement of the pointing device 100 can then be mapped to the displacement of a cursor displayed in a user interface of the user terminal. In other words, x and y displacement values for the cursor can be calculated from the movement of the base unit 101 and the satellite portion 102. The cursor displacement is provided 207 to a software program such that the displacement can be used in the software program. For example, the displacement can be provided to an operating system and used to control the on-screen display of the cursor.

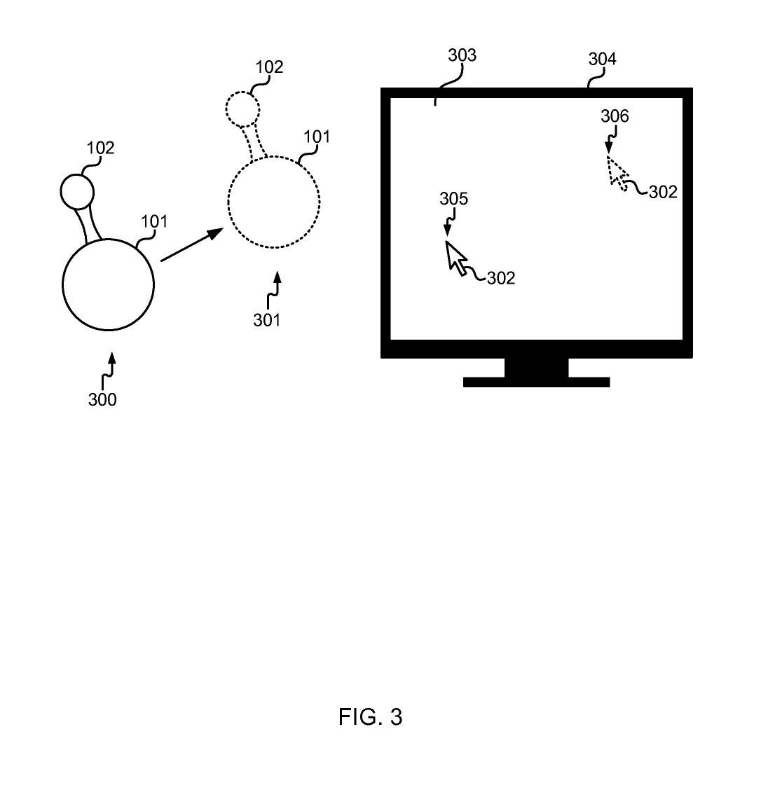

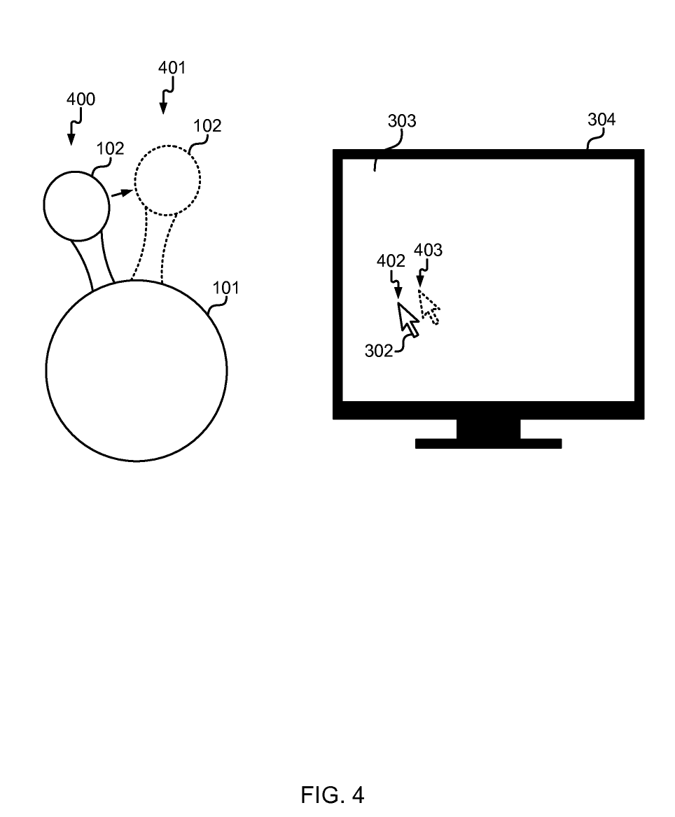

FIGS. 3 and 4 illustrate how the process of FIG. 2 operates when the pointing device 100 is used by a user. Referring first to FIG. 3, a top-down view of the pointing device 100 is shown alongside an example of manipulation of an on-screen cursor. The pointing device 100 is initially located at a first position 300, and the user then moves the pointing device 100 as a whole (i.e. both the base unit 101 and the satellite portion 102) over the surface to a second position 301.

The movement of the base unit 101 is detected by the movement sensor 110, and the movement of the satellite portion 102 is detected by the further movement sensor 114. The movement of the base unit 101 and the satellite portion 102 are substantially the same in the example of FIG. 3. In other words, in the example of FIG. 3, the position of the satellite portion 102 remains substantially constant relative to the base unit 101, despite the overall pointing device 100 moving.

When the movements of the base unit 101 and the satellite portion 102 are compared 206 (in FIG. 2) the similarity between the movement of the base unit 101 and the satellite portion 102 is determined, and if this is within a threshold then it is determined that the pointing device 100 as a whole is being moved by the user. The displacement of the pointing device 100 as a whole is calculated and provided to the operating system of the user terminal. This causes a cursor 302 shown in a user interface 303 on a display 304 of the user terminal to move from a first position 305 to a second position 306. Therefore, the behavior of the pointing device 100 in FIG. 3 is similar to that of a traditional computer mouse.

In contrast, FIG. 4 shows another top-down view of the pointing device 100, and illustrates an alternative way for the pointing device to manipulate the on-screen cursor. In the example of FIG. 4, the base unit 101 remains in a substantially constant position, and the satellite portion 102 (under the control of the user's digit 106) moves from a first position 400 to a second position 401.

The movement of the satellite portion 102 is detected by the further movement sensor 114 and processed by branch 201 in FIG. 2. When the movements of the base unit 101 and the satellite portion 102 are compared 206 (in FIG. 2) the disparity between the movement of the satellite portion 102 and the base unit 101 is noted, and it is determined that only the satellite portion 102 is being moved by the user. The displacement of the satellite portion 102 is provided to the operating system of the user terminal. This causes the cursor 302 shown in a user interface 303 on a display 304 of the user terminal to move in a corresponding way to the user's digit 106. In FIG. 4, the cursor 302 moves from a first position 402 to a second position 403.

In this example, the extent of the movement of the cursor 302 is relatively small compared to that in FIG. 3. In other words, the movement of the base unit and satellite portion together relative to the surface causes a larger displacement of the cursor than a corresponding movement of the satellite portion alone relative to the supporting surface. This is because the processing of the movement data is arranged to apply a weighting factor to the movement of the satellite portion 102 relative to the movement of the overall pointing device 100, such that movements of the satellite portion 102 cause a relatively small displacement of the cursor 302. This enables the user to perform fine control over the cursor using their fingers or thumb (which are very dexterous and able to control fine movements), whereas the user can perform coarse but fast pointing gestures using their arm and wrist to move the overall pointing device 100 (as in FIG. 3). This provides the user with the flexibility to move the cursor rapidly around the display 304 when desired, or move it very carefully when desired.

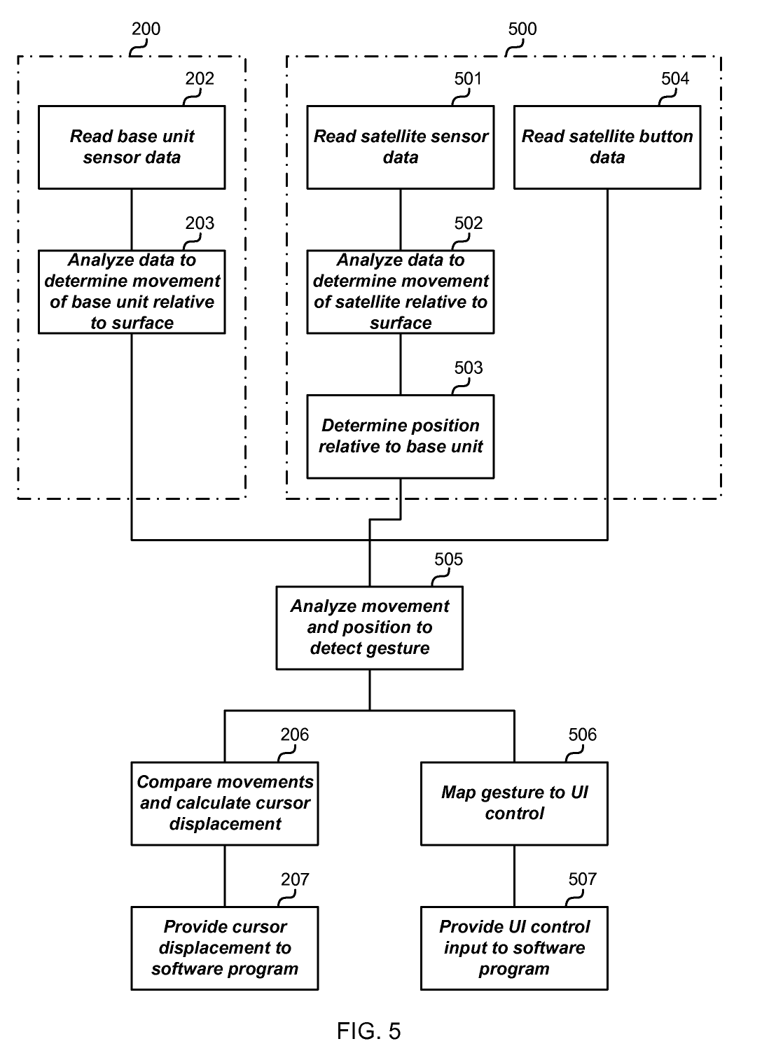

The example described with reference to FIGS. 2 to 4 illustrated how the combination of the movement of the base unit 101 and the satellite portion 102 can be used to precisely control a cursor. In addition, more complex operations can also be performed using the pointing device 100, in particular by analyzing the movement of the satellite portion 102 relative to the base unit 101 to detect more complex gestures being made by the user. This is illustrated in more detail with reference to FIG. 5, below.

FIG. 5 shows a process for operating the pointing device 100 with gesture recognition. As with FIG. 2, two branches of the process are performed substantially concurrently. The first branch 200 is the same as that shown in FIG. 2, such that the movement sensor 110 of the base unit 101 is read, and the movement of the base unit 101 determined.

A second branch 500 extends the functionality of branch 201 of FIG. 2. Firstly, the data from the movement sensor 114 of the satellite portion 102 is read 501. Then, the data is analyzed 502 to determine the movement of the satellite portion 102 relative to the surface 113, in a similar manner to that described above.

The position of the satellite portion 102 relative to the base unit 101 is also determined 503. However, it will be noted that the movement sensor 114 only provides data relating to the movement of the satellite portion 102 relative to the surface 113, and therefore the position of the satellite portion 102 relative to the base unit 101 is not obtained directly from the movement sensor 114 data. The position of the satellite portion 102 relative to the base unit 101 can be obtained, for example, by using additional sensors or derived from the movement sensor data using additional information and processing, as will be described in more detail hereinafter.

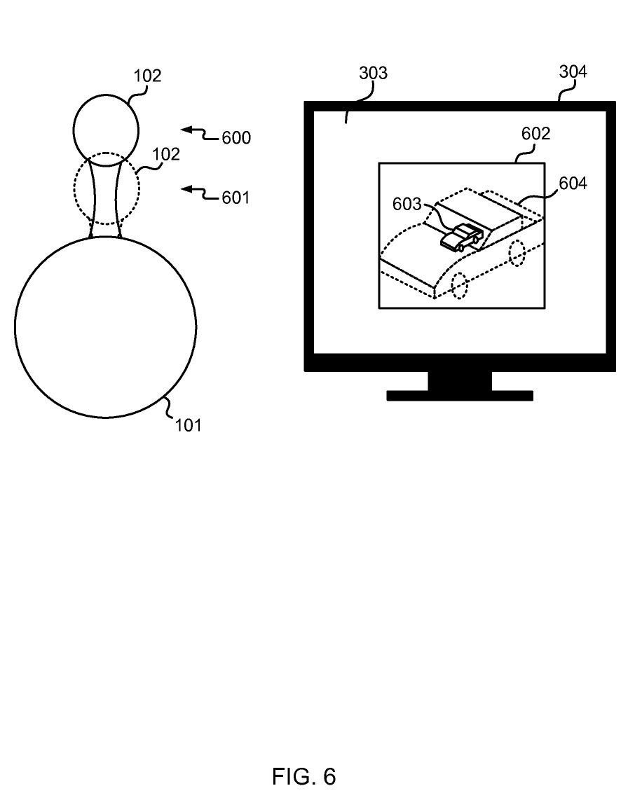

Data from the button 115 on the satellite portion 102 is also read 504, indicating any actuation of the button 115 by the user. The movement of the base unit 101 relative to the surface 113, the movement of the satellite portion 102 relative to the surface 113, the position of the satellite portion 102 relative to the base unit 101, and the button 115 data are then analyzed 505 to detect the presence of a user gesture. Example gestures are illustrated hereinafter (with reference to FIGS. 6, 8 and 9).

If no user gesture is detected, but the pointing device is being moved as described above with reference to FIGS. 2, 3 and 4, then the cursor 302 is controlled as outlined above (i.e. the movement compared 206, cursor displacement calculated and provided 207 to the software program).

If, however, a user gesture is detected, then the particular detected gesture is mapped 506 to a user interface control, such that parameters derived from the gesture (e.g. the size or angle of the gesture) are translated to corresponding software controls. The user interface control is provided 507 to the software program in order to control the display on the user interface, for example to manipulate an on-screen object. In an alternative example, if the gesture is mapped to the execution of a software program, the actuation of a function or a selection from a menu, then an appropriate command is created. The control input derived from the gesture can control either the operating system or an application executed on the operating system.

An example gesture for the pointing device 100 is illustrated with reference to FIG. 6. In the example of FIG. 6, the user is maintaining the position of the base unit 101, and drawing the satellite portion 102 from a first position 600 to a second position 601 closer to the base unit 101. The change in relative position of the satellite portion 102 and the base unit 101 is detected, and this is interpreted as a user gesture, for example indicating a zoom command. For example, responsive to this gesture, an image 602 shown in the user interface 303 of the display 304 can be magnified in order to zoom-in on a small image object 603 and display it as a larger, magnified object 604. The opposite gesture can be performed to zoom-out on the image 602.

In alternative examples, the same operation can be performed using alternative gestures. For example, the user can maintain the position of the satellite portion 102 and move the base unit 101 away from (or toward) the satellite portion 102. In addition, actuation of the button 115 can be incorporated in the gesture, such that the user actuates the button 115 and then moves the satellite portion 102 relative to the base unit 101 to activate the gesture.

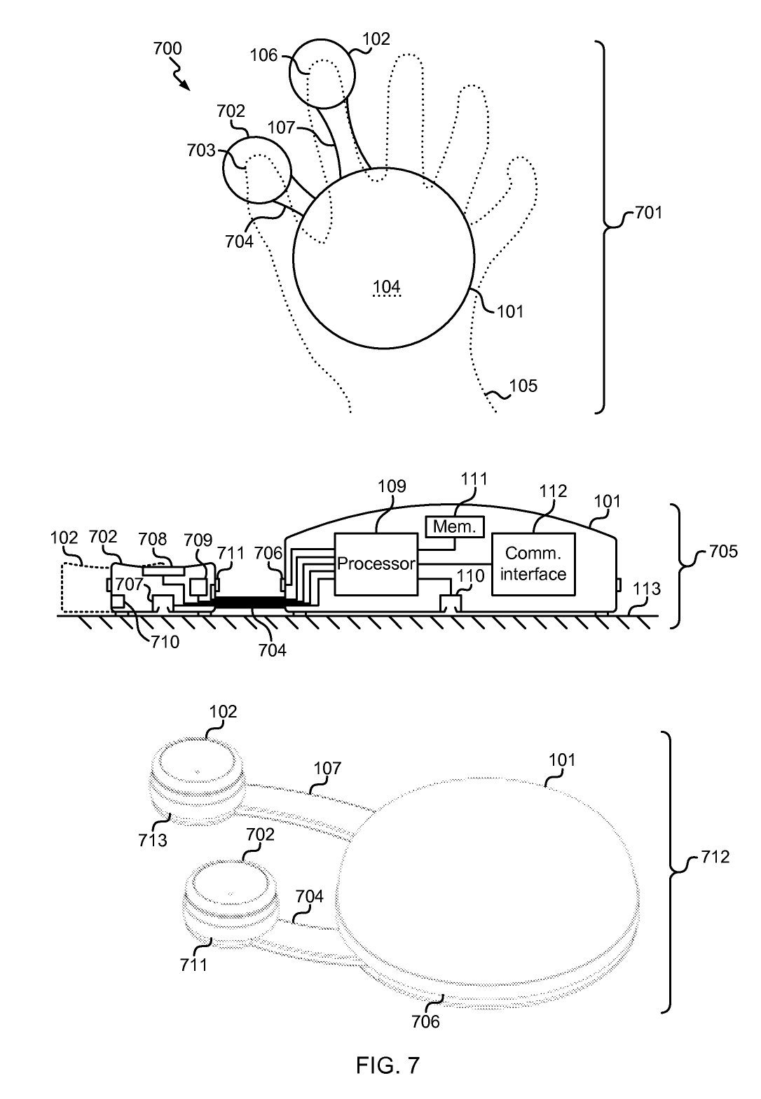

Reference is now made to FIG. 7, which illustrates an alternative example of a pointing device 700 having independently movable portions. In the example of FIG. 7, the pointing device 700 has two satellite portions. As shown in the top-down view 701, the pointing device 700 has a base unit 101 arranged to rest under a palm 104 of a user's hand 105, and a first satellite portion 102 arranged to rest under a first digit 106 of the user's hand 105, as described above with reference to FIG. 1. In addition, the pointing device 700 comprises a second satellite portion 702 arranged to be located under a second digit 703 of the user's hand 105. In the example of FIG. 7, the second digit 703 is the thumb of the user's hand 105, although other digits can be used in alternative examples.

As was the case in the example of FIG. 1, in FIG. 7 the first satellite portion 102 is tethered to the base unit 101 by articulated member 107. The second satellite portion 702 is also tethered to the base unit 101 by articulated member 704. In other examples, however, the satellite portions 102 and 702 can be tethered using a different type of member, or not tethered to the base unit 101, as described in more detail hereinafter.

As shown in side view 705, the base unit 101 of FIG. 1 comprises a processor 109, a movement sensor 110, a memory 111 and a communication interface 112. The movement sensor 110, memory 111, and communication interface 112 are each connected to the processor 109. These functional blocks perform the same functions as described above with reference to FIG. 1.

In addition, the base unit 101 comprises a base contact ring 706 located on the outside periphery of the base unit 101. The base contact ring 706 comprises a conductive portion, and is connected to the processor 109. The function of the base contact ring 706 is described in more detail hereinafter.

Each of the first and second satellite portions 102 and 702 preferably comprise substantially common functionality. In the side view 705 shown in FIG. 7, only the second satellite portion 702 is fully shown, for clarity. In particular, the first satellite portion 102 comprises similar functionality to that described above with reference to FIG. 1, as well as additional functionality described below for the second satellite portion 702.

The second satellite portion 702 comprises a movement sensor 707 connected to the processor 109 via the articulated member 704. The movement sensor 707 is arranged to detect movement of the second satellite portion 702 relative to the supporting surface 113 over which the second satellite portion 702 is moved. The movement sensor 707 outputs a data sequence to the processor 109 that relates to the movement of the second satellite portion 702. The data sequence can be in the form of an x and y displacement in the plane of the surface 113 in a given time. Alternatively, raw data (e.g. in the form of images or a signal having a certain frequency) can be provided to the processor 109, and the processor 109 can determine the x and y displacement from the raw data.

The movement sensor 707 in the second satellite portion 702 can be, for example, an optical sensor, although any suitable sensor for sensing relative motion over a surface can be used (such as ball or wheel-based sensors). Also note that an alternative sensing device for sensing the movement of the second satellite portion 702 can be used instead of a movement sensor located within the satellite portion 702, as outlined below with reference to FIGS. 10 to 13.

The second satellite portion 702 further comprises a button 708 connected to the processor 109 via the articulated member 704, and arranged to provide a signal to the processor 109 when activated by the user. Button 708 is similar to the button 115 described above with reference to FIG. 1. In alternative examples, a pressure sensor or other user-actuatable control can be used instead of, or in combination with, the button 708.

The second satellite portion 702 further comprises an optional haptic feedback actuator 709 connected to the processor 109 via the articulated member 704. The haptic feedback actuator 709 is similar to that described above with reference to FIG. 1, and is arranged to provide haptic feedback to the digit 703 of the user's hand 105 responsive to a command signal from the processor 109.

The second satellite portion 702 also comprises an optional force feedback actuator 710 connected to the processor 109 via the articulated member 704. The force feedback actuator 710 is arranged to influence the movement of the second satellite portion 702 by the digit 703 of the user's hand 105 responsive to a command signal from the processor 109. For example, the force feedback actuator 710 can comprise an electromagnet arranged to attract or repel (depending on the command) a corresponding magnetic element in another satellite portion. Therefore, the user moving the satellite portions feels a force either attracting or repelling the satellite portions from each other. Alternatively, the force feedback actuator 710 can comprise permanent magnets arranged to attract or repel a corresponding magnetic element in another satellite portion (in which case the force feedback actuator 710 is not connected to the processor 109).

Also note that additional or alternative force feedback actuators can also be present within the base unit 101 (not shown in FIG. 7). For example, force feedback actuators can be connected to one or more of the articulated members 107, 704 and arranged to influence their movement, e.g. by restricting, limiting, preventing or encouraging movement of the satellite portions. Such force feedback actuators can be used to simulate the feeling of ‘holding’ an on-screen object between the digits of a user's hand. The force feedback actuators connected to one or more of the articulated members can comprise servo motors.

The second satellite portion 702 further comprises a satellite contact ring 711 located on the outside periphery of the second satellite portion 702. The satellite contact ring 711 comprises a conductive portion, and is connected to the processor 109 via the articulated member 704. The function of the satellite contact ring 711 is described in more detail hereinafter.

Perspective view 712 illustrates the location of the base contact ring 706 on the periphery of the base unit 101, the location of a satellite contact ring 713 on the periphery of the first satellite portion 102, and the location of the satellite contact ring 711 on the periphery of the second satellite portion 702. Each of the contact rings are aligned such that they are able to make electrical contact with each other.

In use, the base unit 101 is arranged to be movable over the supporting surface 113 (such as a desk or table top). The first satellite portion 102 is also arranged to be movable over the supporting surface, and is independently movable relative to the base unit 101. Similarly, the second satellite portion 702 is also arranged to be movable over the supporting surface, and is independently movable relative to both the base unit 101 and the first satellite portion 102. In other words, the tethering (if present) between the satellite portions 102, 702 and the base unit 101 is such that these three elements can be moved separately, individually, and in differing directions if desired.

The data from the base unit 101 is processed using the flowchart illustrated in FIG. 5. Specifically, the first branch 200 is used to process the data from the movement sensor 110 to determine the movement of the base unit 101 relative to the surface 113. The data from the first satellite portion 102 is also processed using the flowchart illustrated in FIG. 5. Specifically, the second branch 500 is used to process the data from the movement sensor 114 of the first satellite portion 102 to determine the movement of the first satellite portion 102 relative to the surface 113, and to determine the position of the first satellite portion 102 relative to the base unit 101. Furthermore, the data from the second satellite portion 702 is processed using a process similar to that shown in the flowchart in FIG. 5. An additional branch is added to the flowchart which is substantially the same as the second branch 500, and this additional branch processes the data from the second satellite portion 702. The additional branch is used to process the data from the movement sensor 707 of the second satellite portion 702 to determine the movement of the second satellite portion 702 relative to the surface 113, and to determine the position of the second satellite portion 702 relative to the base unit 101.

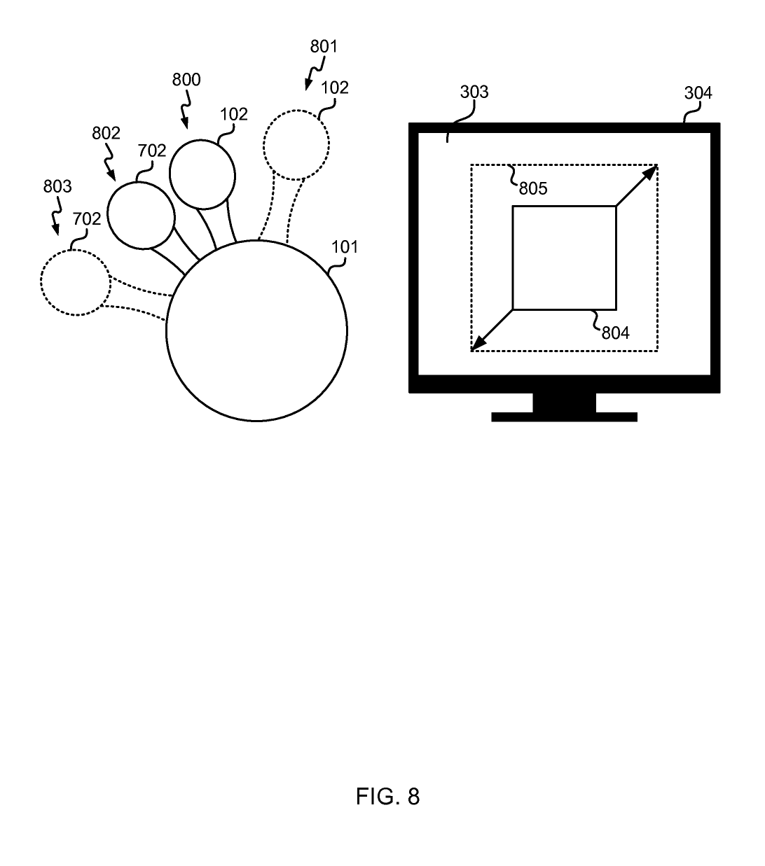

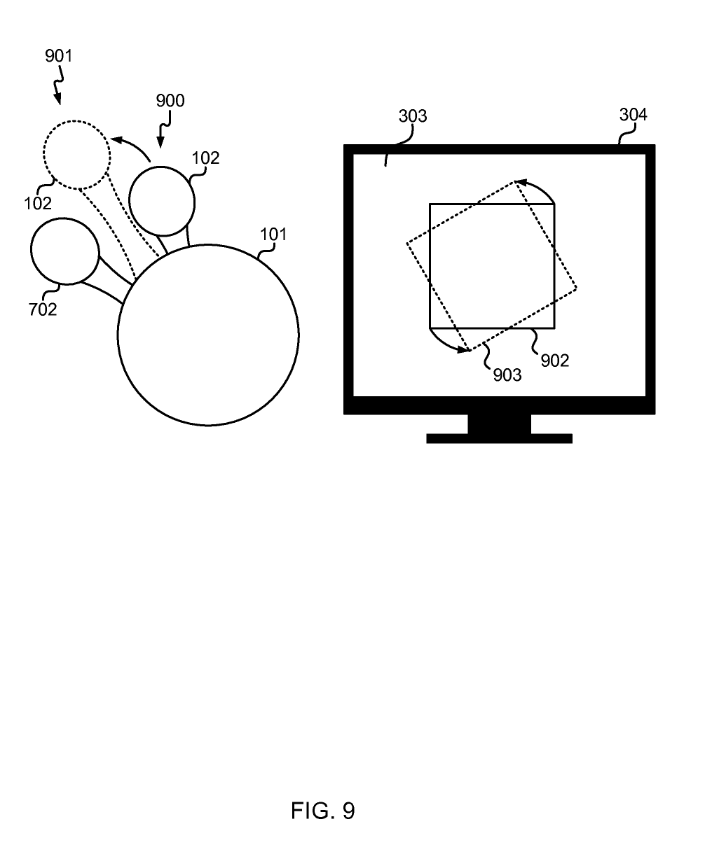

The movement and position data from each of the satellite portions 102, 702 is analyzed with the movement of the base unit 101 to determine whether a user gesture is being performed (as in FIG. 5). Example gestures that can be performed using the pointing device 700 having two satellite portions are outlined with reference to FIGS. 8 and 9. Because the pointing device 700 comprises more than one independently movable satellite portion, this enables the use of ‘multi-touch’ gestures.

FIG. 8 illustrates how the pointing device 700 can be used to manipulate an on-screen object using multi-touch gestures. In the example of FIG. 8, the base unit 101 remains in a substantially constant position, and digit 106 and digit 703 are moved apart from each other, such that the first satellite portion 102 and second satellite portion 702 correspondingly move with their respective digits. The first satellite portion 102 is moved from a first position 800 to a second position 801, and the second satellite portion 702 is moved from a first position 802 to a second position 803.

Because the position of each of the satellite portions relative to the base unit 101 is determined, it can be detected that the two satellite portions are moving apart from each other (or towards each other). This relative motion of the two satellite portions can be interpreted as a gesture to re-size an on-screen object. For example, an object (e.g. a picture) is shown being resized from a first size 804 to a second size 805 on the display 304 responsive to the detected gesture. The extent to which the object is re-sized is related to the extent to which the two satellite portions are moved apart from (or towards) each other.

FIG. 9 illustrates another way in which the pointing device 700 can be used to manipulate an on-screen object. In FIG. 9, the base unit 101 again remains in a substantially constant position. Digit 703 also remains in a substantially constant position, such that the second satellite portion 702 is not substantially moving. Digit 106 is moved by the user such that the first satellite portion 102 is rotated around the second satellite portion 702. The first satellite portion 102 is moved from a first position 900 to a second position 901.

Because the position of each of the satellite portions relative to the base unit 101 is determined, it can be detected that the first satellite portion 102 is moving in an arc about the second satellite portion 702. This motion can be interpreted as a gesture to rotate an on-screen object in the direction in which the first satellite portion 102 is rotated, and by an angle relating to the extent of movement of the first satellite portion 102. For example, an object (e.g. a picture) is shown being rotated from a first orientation 902 to a second orientation 903 on the display 304 responsive to the detected gesture. In an alternative example, both of the satellite portions can move in an arc relative to each other in order to achieve the same effect as shown in FIG. 9.

Note that any suitable multi-touch gesture can be detected by the pointing device 700, in addition to the two discussed with reference to FIGS. 8 and 9. The multi-touch gestures described above can also be combined with actuation commands from button 115 and button 708. Note also that the multi-touch gestures described above can be combined with movement of the pointing device as shown in FIG. 3 to provide cursor control at substantially the same time.

As mentioned with reference to FIG. 5, in order to detect gestures such as those described above (in FIGS. 6, 8 and 9) the position of the one or more satellite portions relative to the base unit is calculated. However, as stated, the movement sensors 114, 707 in the satellite portions provide data relating to the movement of the satellite portions relative to the surface 113, and do not directly provide data relating to the absolute position of the satellite portions relative to the base unit 101. The determination of the current absolute position of the satellite portions relative to the base unit 101 can be performed in a number of ways, as will now be outlined.

A first method for determining the absolute position of the satellite portions relative to the base unit 101 is a ‘dead-reckoning’ technique. The dead-reckoning technique works by maintaining a sum of the relative movements from the movement sensor 114 of the satellite portion 102 from a known starting position. By summing the relative movements of the satellite portion, the absolute position of the satellite portion can be determined.

However, for this technique to be accurate, it is preferable to be able to accurately establish a known starting position of the satellite portion. In addition, it is also preferable to periodically re-start the summing operation from a known position to avoid errors being introduced, for example by the user picking up the pointing device so that the satellite portions move without the movement sensors detecting movement (as they are not close enough to the surface).

The determination of the initial starting position and the periodic re-calibration of the position of the satellite portions for the dead-reckoning technique can be achieved by using the contact rings on the base unit and satellite portions, as illustrated in FIG. 7. The processor 109 is connected to the base contact ring 706, and the first and second satellite contact rings 711, 713. The processor 109 is arranged to detect whenever two or more of the contact rings are in contact with each other. For example, the processor 109 can periodically send a known signal to one contact ring, and listen for the signal from the other contact rings. If the signal is received, this indicates these contact rings are in contact with each other.

When the first satellite contact ring 713 is in contact with the base contract ring 706, then it can be determined that the first satellite portion 102 has been drawn as close as possible to be base unit 102. This therefore establishes a known position for the first satellite portion 102. Similarly, when the second satellite contact ring 711 is in contact with the base contract ring 706, then it can be determined that the second satellite portion 702 has been drawn as close as possible to be base unit 102, which establishes a known position for the second satellite portion 702. As these events occur frequently during natural use of the pointing device 700, the position of the satellite portions can be re-calibrated when this occurs, in order to maintain the accuracy of the dead-reckoning technique.

In addition, when two satellite portions are in contact with each other (but not in contact with the base) this can also be used as an event to re-calibrate the dead-reckoning measurement. Although this event does not provide information regarding the absolute position relative to the base unit, it does enable the position of the two satellite portions relative to each other to be corrected. Having accurate information regarding the relative position of the satellite portions is beneficial for accurate gesture recognition.

The accuracy of the position determination using the contact rings can be further improved by using more complex contact ring arrangements. For example, a more accurate position can be determined by knowing the circumferential location on the contact rings where the contact is occurring. This can be achieved, for example, by using a contact ring (e.g. the base contact ring) formed from a resistive track, such that the electrical resistance changes along its length (either continuously or in discretely). If a known voltage is passed through the resistive track, then another contact ring contacting the resistive track ‘taps-off’ a proportion of that known voltage related to the distance along the resistive track. The magnitude of the tapped off voltage can be measured by the processor 109 and used to determine the circumferential position (the radial position is known due to the fixed size of the contact ring).

In an alternative example, the contact rings can be divided into a plurality of known segments, each connected to the processor 109. In this way, the individual segment making contact with another contact ring/segment can be detected, which provides more accurate position information.

The accuracy of the position determination of the satellite portions relative to the base unit can be yet further improved by relocating the movement sensors of the satellite portions, as illustrated with reference to FIG. 10. The pointing device in FIG. 10 is substantially the same as those illustrated in FIG. 1 and FIG. 7, except that the satellite portion 102 does not comprise a movement sensor. Instead, a movement sensor 1000 is connected to the articulated member 107 such that movement of the satellite portion 102 causes corresponding movement of the articulated member 107, which in turn causes the movement sensor 1000 to move. Therefore, the movement data from the movement sensor 1000 can be directly related to the movement of the satellite portion 102 over the surface 113.

However, the movement sensor 1000 is not sensing the movement over the surface 113, but is instead sensing the movement over an inside surface 1001 of the base unit 101. Therefore, even if the pointing device is lifted off the surface (e.g. to reposition it on the desk), the movement of the satellite portion 102 can still be measured because the movement sensor 1000 still has a nearby surface from which to read movement. As a result of this, the dead-reckoning technique is made more accurate, as the absolute position is not lost whenever the pointing device is lifted off the surface 113. This can also be combined with the use of contact rings for determining the absolute position, as described above.

Note that whilst FIG. 10 only illustrates the first satellite portion 102, for clarity, further satellite portions can also be present. Each of the further satellite portions can have their movement sensor connected to the articulated member, in a similar way to that described above.

As an alternative to the use of the dead-reckoning technique for determining the absolute position of the satellite portions, additional sensors can be provided in the pointing device to provide absolute position data. For example, absolute position sensors, such as potentiometers or rotary encoders, can be provided in the base unit connected to the articulated member. The absolute position sensors provide data indicating the absolute position of the articulated member, which can be translated to the absolute position of the satellite portion relative to the base unit. Such sensors can be combined with the movement sensors, such that the movement sensors provide data regarding the movement of the satellite portions, and the absolute position sensors provide data regarding their absolute position.

In a further alternative, the dead-reckoning technique can be used in combination with low-resolution absolute position sensors to prevent the position estimation becoming excessively inaccurate (e.g. in the case that the pointing device is lifted off the surface).

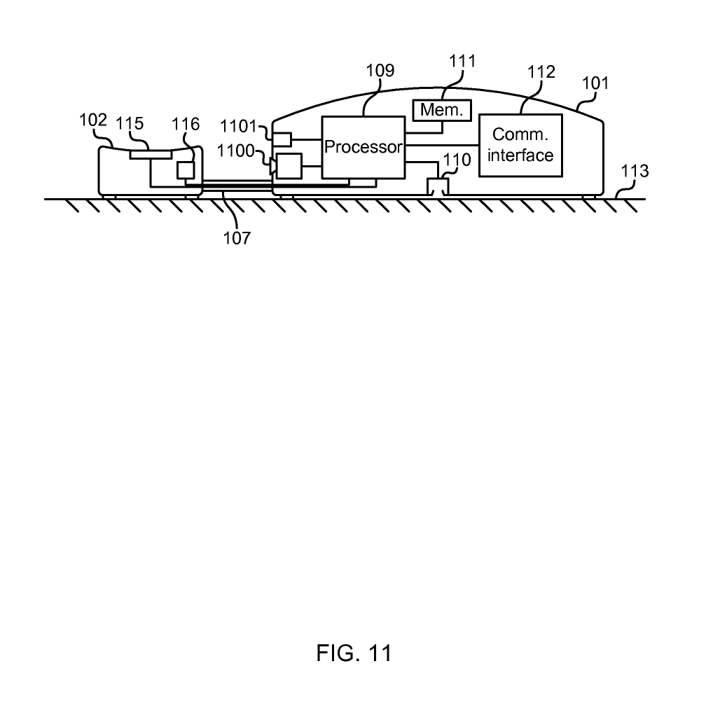

Reference is now made to FIG. 11, which illustrates an alternative technique for sensing the movement and position of the satellite portion 102. The pointing device shown in FIG. 11 is similar to that shown in FIG. 1 or 7, except that the satellite portion (or portions) do not comprise a movement sensor. Instead, an image capture device 1100 is mounted in the base unit 101 and connected to the processor 109. The image capture device 1100 is arranged to capture a sequence of images and provide these to the processor 109. Computer vision techniques can be used to analyze the sequence of images, and determine the location of the satellite portion in the images. The location of the satellite portion in the images can be mapped to the absolute position of the satellite portion relative to the base unit.

By tracking the movement of the satellite portions in the image sequence, the pointing device illustrated in FIG. 11 is therefore able to provide information regarding the movement of the satellite portions, as well as the absolute position of the satellite portion relative to the base unit, without requiring the dead-reckoning technique.

Optionally, the base unit 101 can also comprise an illumination source 1101 arranged to illuminate the satellite portion to assist in the image capture. For example, the image capture device can be an infrared (IR) camera, and the illumination source can be an IR illumination source (such as an IR LED).

When the image capture device 1100 is mounted in the base unit as shown in FIG. 11, then the distance of the satellite portion from the base unit can be determined by using the pixel intensity in the captured image as a measure of the distance. The accuracy of this can be improved if the reflectivity of the satellite portion is pre-known. In alternative examples, a 3D camera (such as a time-of-flight camera) or stereo camera can be used to determine the distance of the satellite portion from the base unit.

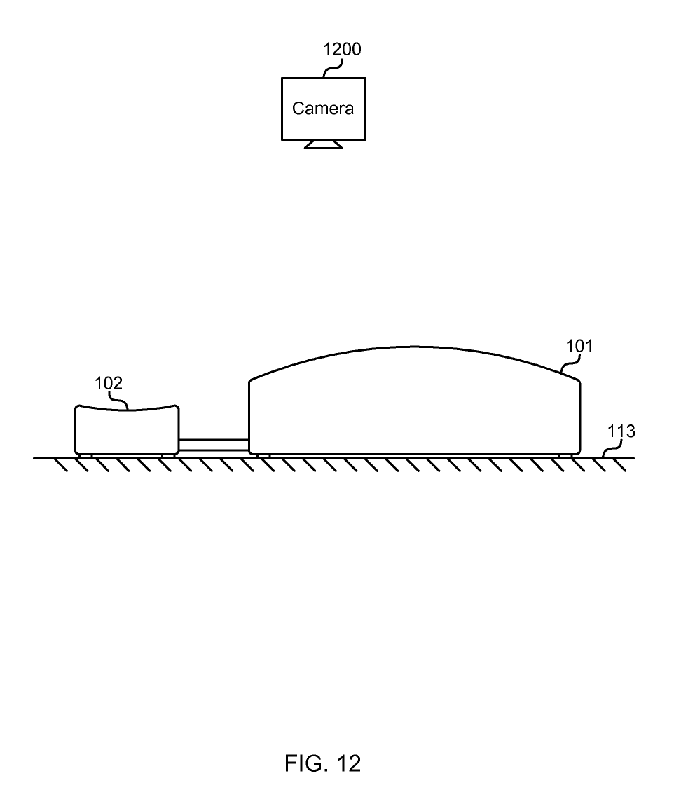

A further image capture device-based example is illustrated in FIG. 12. In this example, a separate image capture device 1200 is located above the pointing device. The image capture device 1200 provides a sequence of images that show the position of the base unit and satellite portions. The sequence of images can be processed using computer vision techniques to determine the movement and relative position of the base unit and satellite portions. In some examples, only the image capture device can be used to determine the movement and position of both the base unit and satellite portions. In other examples, the image capture device can be used in combination with movement sensors in the base unit and/or the satellite portions to determine the movement.

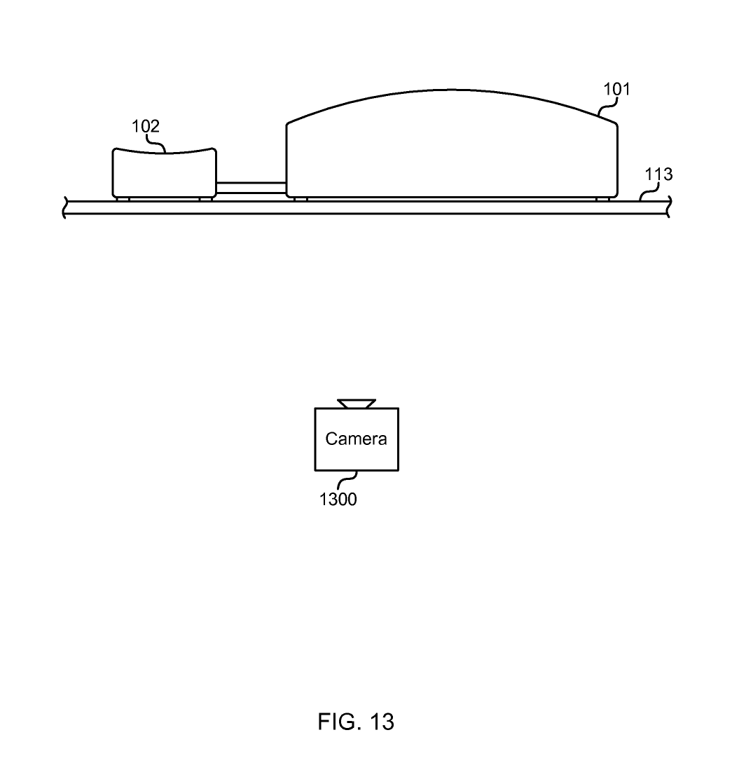

Another image capture device-based example is illustrated in FIG. 13. In this example, a separate image capture device 1300 is located below the pointing device. Such an arrangement can be used, for example, in the case of surface computing devices, where imaging through a screen 1301 can be performed. As above, the image capture device 1300 provides a sequence of images that show the position of the base unit and satellite portions. The sequence of images can be processed using computer vision techniques to determine the movement and relative position of the base unit and satellite portions. In some examples, only the image capture device can be used to determine the movement and position of both the base unit and satellite portions. In other examples, the image capture device can be used in combination with movement sensors in the base unit and/or the satellite portions to determine the movement.

In the previously illustrated examples, each of the satellite portions were tethered to the base unit using an articulated member. In alternative examples, the satellite portions can be tethered to the base unit using a flexible, deformable or retractable member. This can be, for example, in the form of a bendable linkage, membrane or cable. In a further example, the communication between the satellite portion and the base unit can be wireless, and the satellite portion not tethered to the base unit. For example, the satellite portion can communicate with the base unit using a short range radio link, such as Bluetooth.

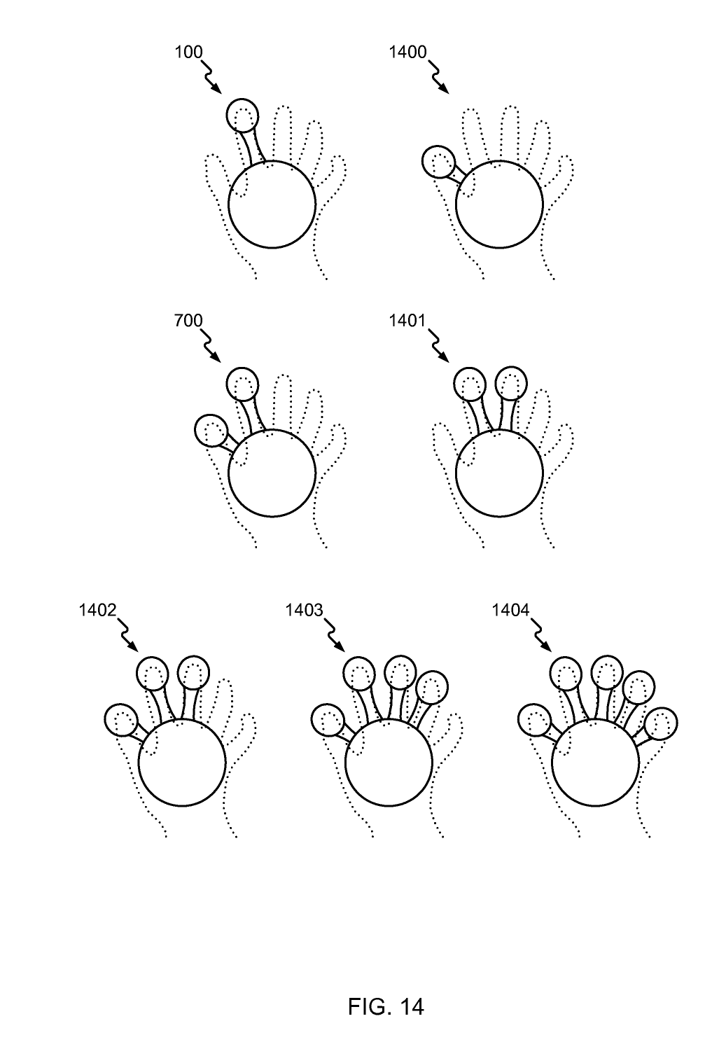

Furthermore, in the previous illustrated examples, only one satellite portion was shown arranged to sit under the forefinger (FIG. 1), or two satellite portions were shown arranged to sit under the forefinger and thumb (FIG. 7). However, any configuration or number of satellite portions can be provided, as illustrated in FIG. 14. FIG. 14 shows the pointing devices 100 and 700 described hereinabove, as well as other alternative examples using one satellite portion 1400, two satellite portions 1401, as well as examples using three 1402, four 1403, and five 1404 satellite portions. In one example, the satellite portions can be added or removed by the user, so that the user can configure the number of satellite portions that are appropriate for the task they are going to perform with the pointing device.

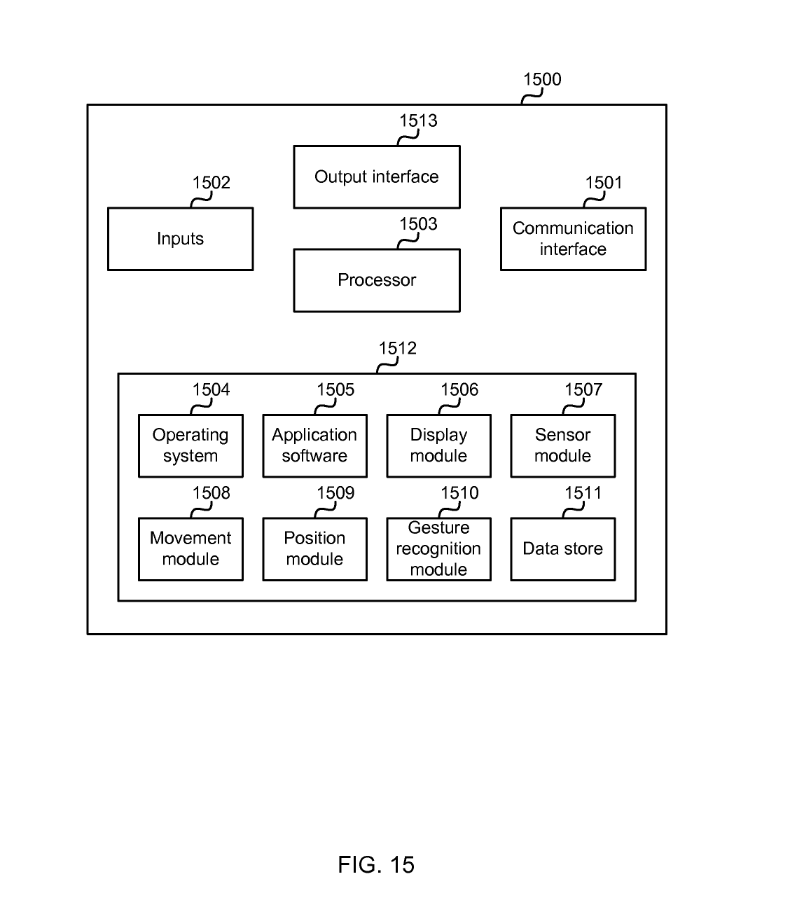

FIG. 15 illustrates various components of an exemplary computing-based device 1500 which can be implemented as any form of a computing and/or electronic device, and in which embodiments of the techniques for using a pointing device with independently movable portions described herein can be implemented.

The computing-based device 1500 comprises a communication interface 1501, which is arranged to communicate with a pointing device having independently movable portions. The computing-based device 1500 also comprises one or more further inputs 1502 which are of any suitable type for receiving media content, Internet Protocol (IP) input or other data.

Computing-based device 1500 also comprises one or more processors 1503 which can be microprocessors, controllers or any other suitable type of processors for processing computing executable instructions to control the operation of the device in order to perform the techniques described herein. Platform software comprising an operating system 1504 or any other suitable platform software can be provided at the computing-based device to enable application software 1505 to be executed on the device. Other software functions can comprise one or more of:
A display module 1506 arranged to control the display device 304, including for example the display of a cursor in a user interface;
A sensor module 1507 arranged to read data from the movement sensors of the base unit and satellite portions;
A movement module 1508 arranged to determine the movement of the base unit and satellite portions from the movement sensor data;
A position module 1509 arranged to read sensor data and determine the position of the satellite portions relative to the base unit;
A gesture recognition module 1510 arranged to analyze the position data and/or the movement data and detect user gestures; and
A data store 1511 arranged to store sensor data, images analyzed data etc.

The computer executable instructions can be provided using any computer-readable media, such as memory 1512. The memory is of any suitable type such as random access memory (RAM), a disk storage device of any type such as a magnetic or optical storage device, a hard disk drive, or a CD, DVD or other disc drive. Flash memory, EPROM or EEPROM can also be used.

An output interface 1513 is also provided such as an audio and/or video output to a display device 304 integral with or in communication with the computing-based device 1500. The display device 304 can provide a graphical user interface, or other user interface of any suitable type.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A pointing device, comprising:
a base unit arranged to be located under a palm of a user's hand and be movable over a supporting surface; and
a satellite portion arranged to be located under a digit of the user's hand and be independently movable over the supporting surface relative to the base unit.

2. A pointing device according to claim 1, wherein the satellite portion comprises a movement sensor arranged to generate a data sequence relating to sensed movement of the satellite portion relative to the supporting surface.

3. A pointing device according to claim 1, wherein the satellite portion is tethered to the base unit.

4. A pointing device according to claim 3, wherein the satellite portion is tethered to the base unit via an articulated member.

5. A pointing device according to claim 4, wherein the base unit comprises a movement sensor connected to the articulated member such that the movement sensor is arranged to generate a data sequence relating to the position of the satellite portion relative to an inside surface of the base unit.

6. A pointing device according to claim 1, wherein the base unit comprises a movement sensor arranged to generate a data sequence relating to sensed movement of the base unit relative to the supporting surface.

7. A pointing device according to claim 1, wherein the base unit comprises a sensing device arranged to generate a data sequence relating to the position of the satellite portion relative to the base unit.

8. A pointing device according to claim 1, further comprising a further satellite portion arranged to be located under a further digit of the user's hand and be independently movable over the supporting surface relative to the satellite portion and the base unit.

9. A pointing device according to claim 1, wherein the satellite portion comprises a haptic feedback actuator arranged to provide haptic feedback to the digit of the user's hand responsive to a command signal.

10. A pointing device according to claim 1, wherein the pointing device comprises a force feedback actuator arranged to influence movement of the satellite portion by the digit of the user's hand responsive to a command signal.

11. A pointing device according to claim 1, wherein the base unit comprises a first conductive portion at its periphery and the satellite portion comprises a second conductive portion at its periphery, and the pointing device is arranged to detect contact between the first conductive portion and second conductive portion.

12. One or more tangible device-readable media with device-executable instructions for performing steps comprising:
reading data from at least one sensing device;
calculating movement of a base unit of a pointing device from the data;
calculating movement of an independently movable satellite portion of the pointing device from the data; and
analyzing the movement of the base unit and the satellite portion to detect a user gesture.

13. One or more tangible device-readable media according to claim 12, further comprising device-executable instructions for controlling a software program in accordance with the user gesture detected.

14. One or more tangible device-readable media according to claim 12, wherein the steps of calculating movement of the base unit and calculating movement of the independently movable satellite portion are performed substantially concurrently.

15. One or more tangible device-readable media according to claim 12, wherein the movement of the base unit and the movement of the satellite portion is relative to a supporting surface, and the one or more tangible device-readable media further comprises device-executable instructions for controlling the position of a cursor in a user interface in accordance with the movement of the base unit relative to the supporting surface and the movement of the satellite portion relative to the supporting surface.

16. One or more tangible device-readable media according to claim 15, wherein the movement of the base unit and the satellite portion together relative to the supporting surface causes a larger displacement of the cursor than a corresponding movement of the satellite portion alone relative to the supporting surface.

17. One or more tangible device-readable media according to claim 12, further comprising device-executable instructions for calculating a position of the satellite portion relative to the base unit.

18. One or more tangible device-readable media according to claim 17, wherein the step of calculating the position of the satellite portion relative to the base unit comprises using the movement calculated for the satellite portion to track the position of the satellite portion from an initial known location.

19. One or more tangible device-readable media according to claim 17, wherein the at least one sensor comprises one of a camera and an absolute position sensor arranged to determine the position of the satellite portion relative to the base unit, and the step of calculating the position of the satellite portion relative to the base unit comprises reading satellite portion position data from the at least one sensor.

20. A computer mouse device, comprising:
a base unit arranged to be located under a palm of a user's hand and be movable over a supporting surface;
a satellite portion tethered to the base unit, and arranged to be located under a digit of the user's hand and be independently movable over the supporting surface relative to the base unit;
a sensing device arranged to generate a data sequence relating to sensed movement of the base unit; and
a further sensing device arranged to generate a further data sequence relating to sensed movement of the satellite portion.
